(19) United States
(12) Patent Application Publication
(10) Pub. No.: US 2013/0322051 A1
(43) Pub. Date: Dec. 5, 2013

(54) Reflector Apparatus with a Multiple Reflector Arrangement

(71) Applicant: Sergio Alejandro Ortiz-Gavin, Los Angeles, CA (US)

(72) Inventor: Sergio Alejandro Ortiz-Gavin, Los Angeles, CA (US)

(21) Appl. No.: 13/488,379

(22) Filed: Jun. 4, 2012

(51) Int. Cl. G03B 15/06

(52) U.S. Cl. CPC G03B 15/06
USPC 362/11; 362/16; 362/17

(57) ABSTRACT

A light shaping tool with a multiple reflector arrangement to produce varied light and diffused light. A combination of varied light sources that complement each other is configured in an apparatus to produce desirable lighting. Different combinations of light reflecting surfaces and materials are configured to cooperate in a multiple reflector arrangement to produce and shape light for stage, studio, motion picture and still photography.

### RELATED APPLICATION DATA

This application claims the benefit of U.S. patent application Ser. No. 12/399,924, titled Dynamic Alternating Panel Reflector Apparatus filed on Mar. 6, 2009 which claims the benefit of U.S. Provisional Patent Application Ser. No. 61/068,579 filed on Mar. 6, 2008.

### BACKGROUND OF THE INVENTION

1. Field of the Invention

This present invention is directed to improved reflectors and light shaping tools for stage, studio, motion picture and still photography.

2. Description of the Related Art

Photographers use different types of lighting apparatus to create varied diffused light for photographing their subjects. Light directly from a light source, such as a strobe, comes in a straight line and can produce harsh, hard shadows on a subject. Conventional apparatus can create soft diffused light by directing light through a diffusing material or by bouncing light off a second surface. In the conventional reflectors, light from a bulb is bounced off the inside of the metalized umbrella to create a soft indirect light that creates softer shadows on the subject. A need exists for improved reflectors and light shaping tools that expand lighting options for photographers to shape the light and produce varied and diffuse lighting to photograph their subjects.

### SUMMARY OF THE INVENTION

The use of a multiple reflector arrangement in an apparatus as described herein to produce varied light and diffused light for stage, studio, motion picture and still photography. The invention includes different combinations of light reflecting surfaces and materials arranged to cooperate together to produce highly creative lighting. Embodiments of the invention include a complex layering of different light sources that complement each other in one apparatus to produce highly desirable lighting. Other and further advantages will appear to skilled persons from the written disclosure and figures.

### BRIEF DESCRIPTION OF THE DRAWINGS

FIG. 1 is a perspective view of one embodiment of the invention.

FIG. 2 is a perspective view of an embodiment of the invention.

FIG. 3 is a perspective view of one embodiment of the invention with a second light source.

FIG. 4 is another perspective view of an embodiment of the invention.

FIG. 5 is a front elevation view of one embodiment of the invention with an arrangement of LED lights.

FIG. 6 is a view of one embodiment of the invention illustrating an arrangement of LED lights on a panel of the reflector.

FIG. 7 is a view of an embodiment of the invention illustrating an arrangement of LED lights on a panel of the reflector.

FIG. 8 is a view of a further embodiment of the invention showing an arrangement of LED lights on a panel of the reflector.

FIG. 9 is an elevation view of embodiments of the invention illustrating one arrangement of panels on the light reflecting surface of the second reflector.

FIG. 10 is an elevation view of embodiments of the light reflecting surface in a shift configuration.

FIG. 11 is an elevation view of embodiments of the light reflecting surface in a checkered shift configuration.

FIG. 12 is an elevation view of embodiments of the light reflecting surface in a half and half configuration.

FIG. 13 is an elevation view of embodiments of the light reflecting surface in a half and half configuration.

FIG. 14 is an elevation view of embodiments of the light reflecting surface in a tricolor configuration.

FIG. 15 is an elevation view of embodiments of the light reflecting surface in a tricolor shift configuration.

FIG. 16 is an elevation view of embodiments of the light reflecting surface with a center portion having a separate color.

### DETAILED DESCRIPTION OF EMBODIMENTS OF THE INVENTION

Reference is made to the Figures in which elements of the illustrated embodiments of the invention are given numerical designations so as to enable one skilled in the art to make and use the invention. It is understood that the following description is exemplary of embodiments of the invention and it is apparent to skilled persons that modifications are possible without departing from the inventive concepts herein described. As described herein, the color champagne includes the typical color of the beverage champagne including pale tints of yellowish orange that are close to a beige color. The term silver includes the well known silver colors including a soft silver color and a hard silver color that includes tints of gray.

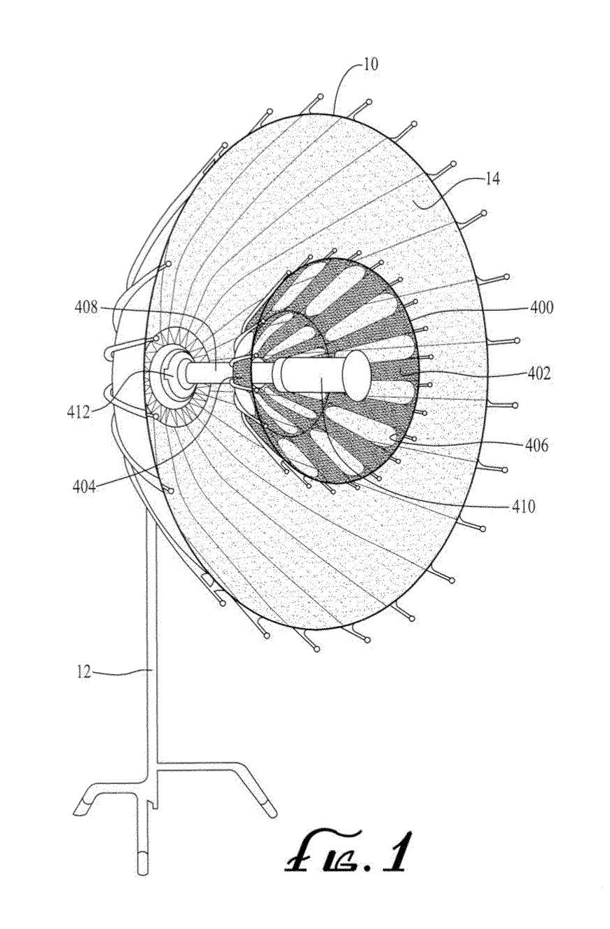

In the embodiment shown in FIG. 1, a first reflector 400 is illustrated with an inner light reflecting surface 402 and an exterior light reflecting surface 404. The first reflector 400 includes one or more apertures 406 extending from the inner surface 402 to the exterior surface 404 as shown in FIG. 1. In embodiments of the invention, the first reflector 400 includes different arrangements of apertures 406 including the nonsymmetrical arrangement of apertures 406 and apertures 406 of different sizes and shapes. The inner light reflecting surface 402 and the exterior light reflecting, surface 404 of the first reflector 400 are made of one or more reflective materials and surfaces known to skilled persons, including metalized film, metal foil, silver, aluminum, gold chrome, nickel, steel, a white color or other selected color surface and a ceramic surface.

The inner light reflecting surface 402 and the exterior light reflecting surface 404 of the first reflector 400 can be glued, laminated or painted onto a polyester textile material or nylon, fiberglass, KEVLAR, cotton or a combination of these materials and any other suitable materials used to construct a reflector known to skilled persons. The first reflector 400 includes, but is not limited to, a parabolic reflector configuration known to skilled persons.

The first reflector 400 is arranged about the focusing tube 408. The light source 410 is attached to one end of the focusing tube 408 as shown in FIG. 1. The light source 410 includes a photo flash tube, a tungsten/halogen lamp, an HMI lamp, sodium vapor lamp and light sources known to skilled persons in the art of stage, studio, motion picture and production lighting. In the embodiment shown in FIG. 1, the first reflector 400 is axially adjacent to the light source 410 in a position along the longitudinal axis of the focusing tube 408.

The focusing tube 408 is connected to an electrical power source (not shown) to supply electrical power to the light source 410. The focusing tube 408 is directed through a hub support 412 and can be connected to a support 12 shown in FIG. 1 in a conventional manner including a clamp (not shown) well known to skilled persons.

FIG. 1 illustrates the second reflector 10 that includes a light reflecting surface 14. The second reflector 10 is arranged about the focusing tube 408 and in one or more embodiments is supported on the hub support 412. In the embodiment shown in FIG. 1, the second reflector 10 is configured axially adjacent to the exterior light reflecting surface 404 of the first reflector 400 along the longitudinal axis of the focusing tube 408. The second reflector 10 includes, but is not limited to, the parabolic reflectors well known to persons skilled in the art.

The light reflecting surface 14 is made of one or more reflective materials and surfaces known to skilled persons, including metalized film, metal foil, silver, aluminum, gold chrome, nickel, steel, a white color or other selected color surface and a ceramic surface. The surface 14 can be glued, laminated or painted onto a polyester textile material or nylon, fiberglass, KEVLAR, cotton or a combination of these materials and other suitable materials used to construct a reflector known to skilled persons.

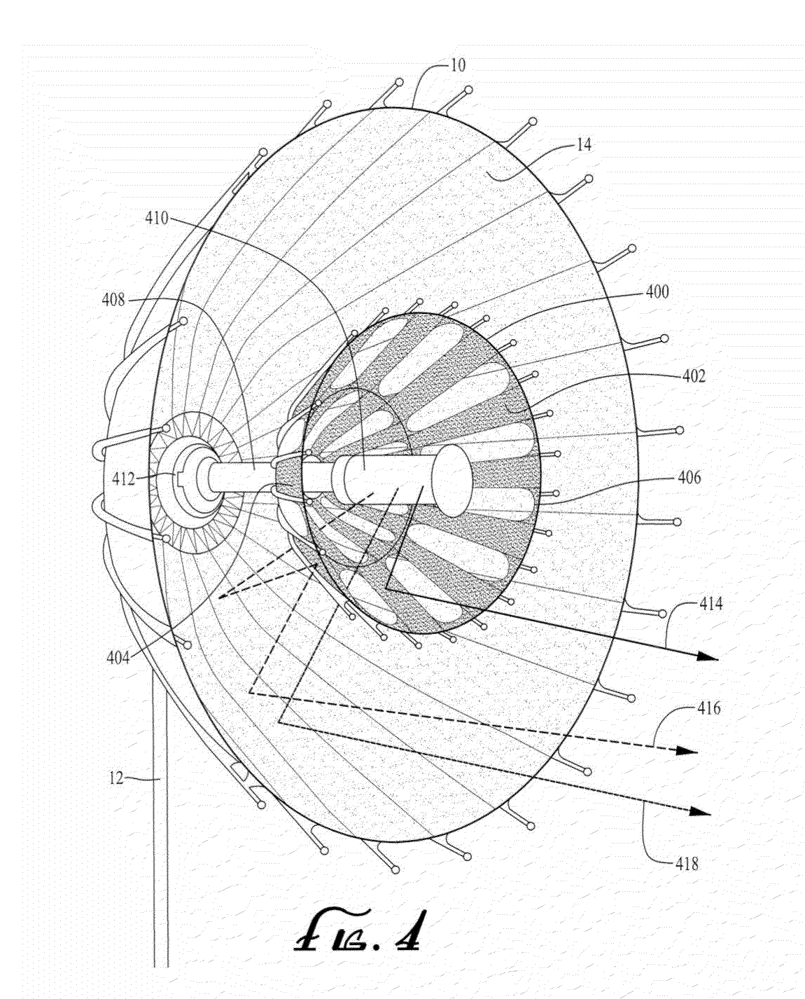

In the embodiment shown in FIG. 1, the first reflector 400 and the second reflector 10 cooperate to reflect light from the light source 410 for stage, studio, motion picture and still photography. As one illustrative example, as shown in FIG. 4, the light ray 414 from the light source 410 is reflected off the inner light reflecting surface 402 to produce reflected light. As another illustrative example, as shown in FIG. 4, the light ray 416 passes through aperture 406, is reflected off of the light reflecting surface 14 of the second reflector 10, then reflected off of the exterior light reflecting surface 404 of the first reflector 400 and then again reflected off of the light reflecting surface 14 of the second reflector 10 to produce reflected light. As a further illustrative example, as shown in FIG. 4, the light ray 418 passes through another aperture 406 and is reflected from the light reflecting surface 14 of the second reflector 10 to reflect light.

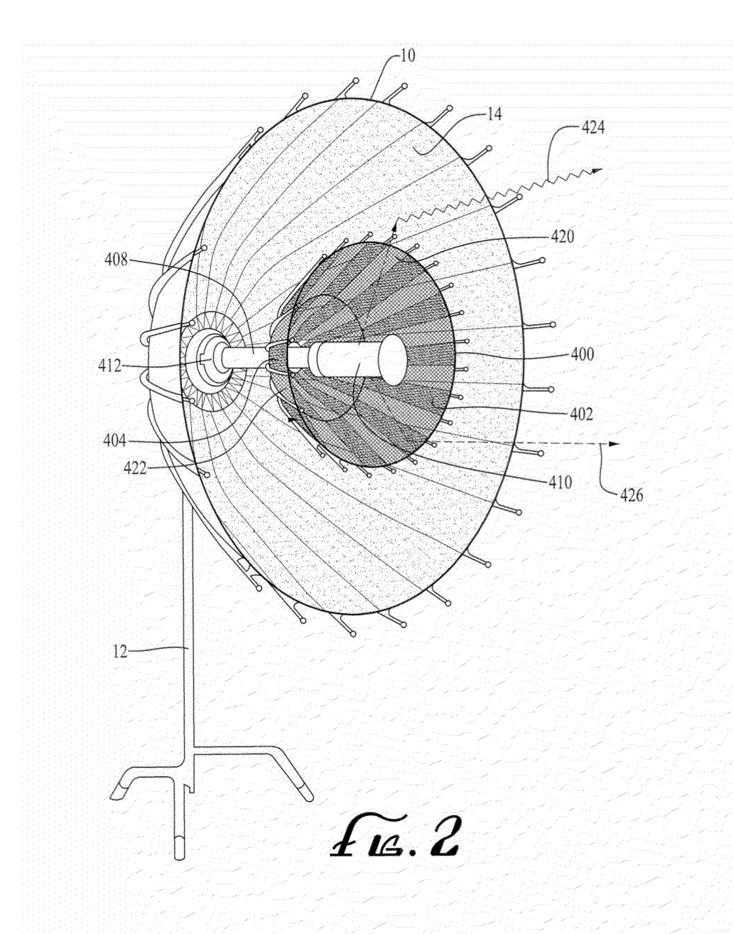

In the embodiment shown in FIG. 2, the first reflector 400 includes translucent panels 420 on the inner light reflecting surface 402 and includes translucent panels 422 on the exterior light reflecting surface 404 that cooperate to produce diffused light. The present invention includes the translucent panels 420 and 422 asymmetrically arranged on the first reflector 400 and includes the panels 420 and 422 configured of different sizes and shapes. The translucent panels 420 and translucent panels 422 can be constructed of silk, polyester, cotton, nylon, fiberglass and other translucent materials known to skilled persons all of which are within the scope of the present invention.

In the embodiment shown in FIG. 2, the first reflector 400 and the second reflector 10 cooperate to reflect light from the light source 410 including diffused light. As one illustrative example, light ray 424 from the light source 410 passes through the translucent panels 420 and 422 as shown in FIG. 2 and then is reflected off of the light reflecting surface 14 of the second reflector 10 to produce reflected light with diffusive qualities. As another illustrative example, light ray 426 from the light source 410 is reflected off of the inner light reflecting surface 402 of the first reflector 400.

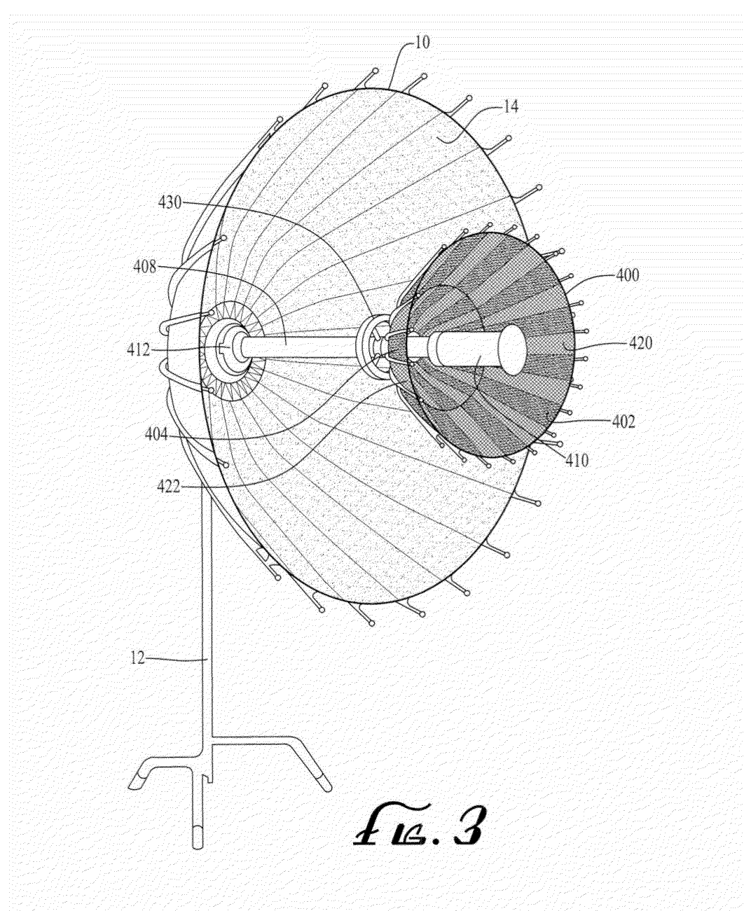

In FIG. 3, a second lamp 430 is included in this embodiment and is positioned between the first reflector 400 and the second reflector 10. The second lamp 430 may be positioned on the focusing tube 408 as shown in FIG. 3. In embodiments of the invention, the first reflector 400 can be displaced along the focusing tube 408 and positioned along the length of the focusing tube 408 to produce desired lighting effects. The second lamp 430 includes photo flash tubes, a tungsten/halogen lamp, an HMI lamp, sodium vapor lamp and light sources known to skilled persons in the art of stage, studio, motion picture and production lighting.

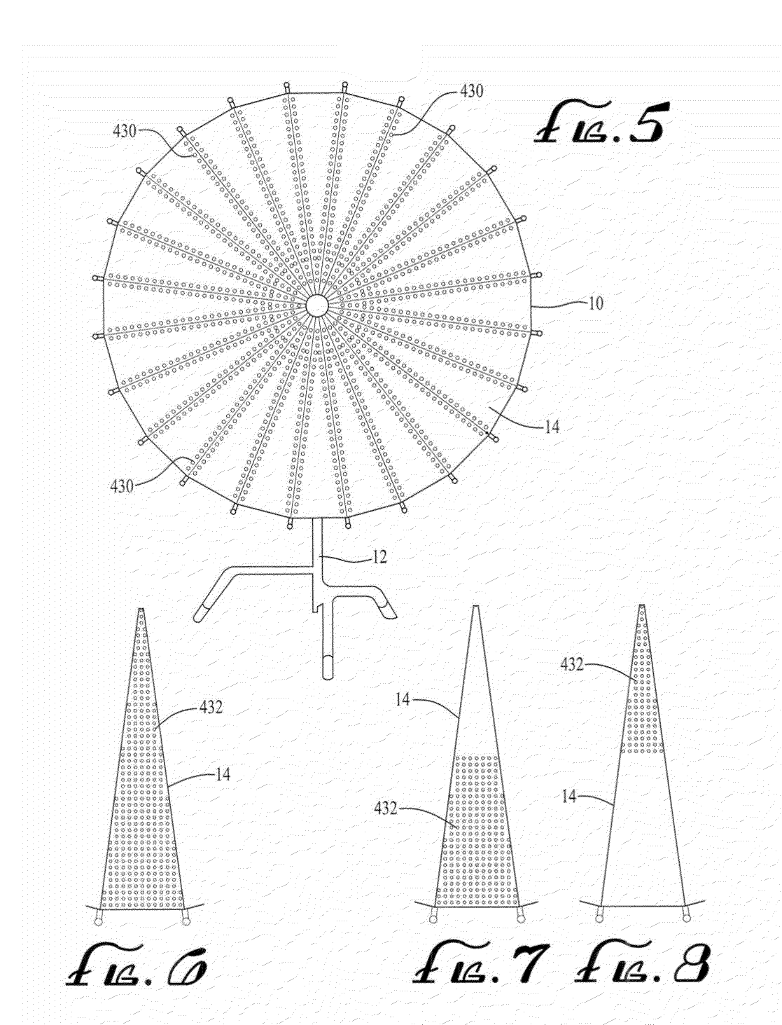

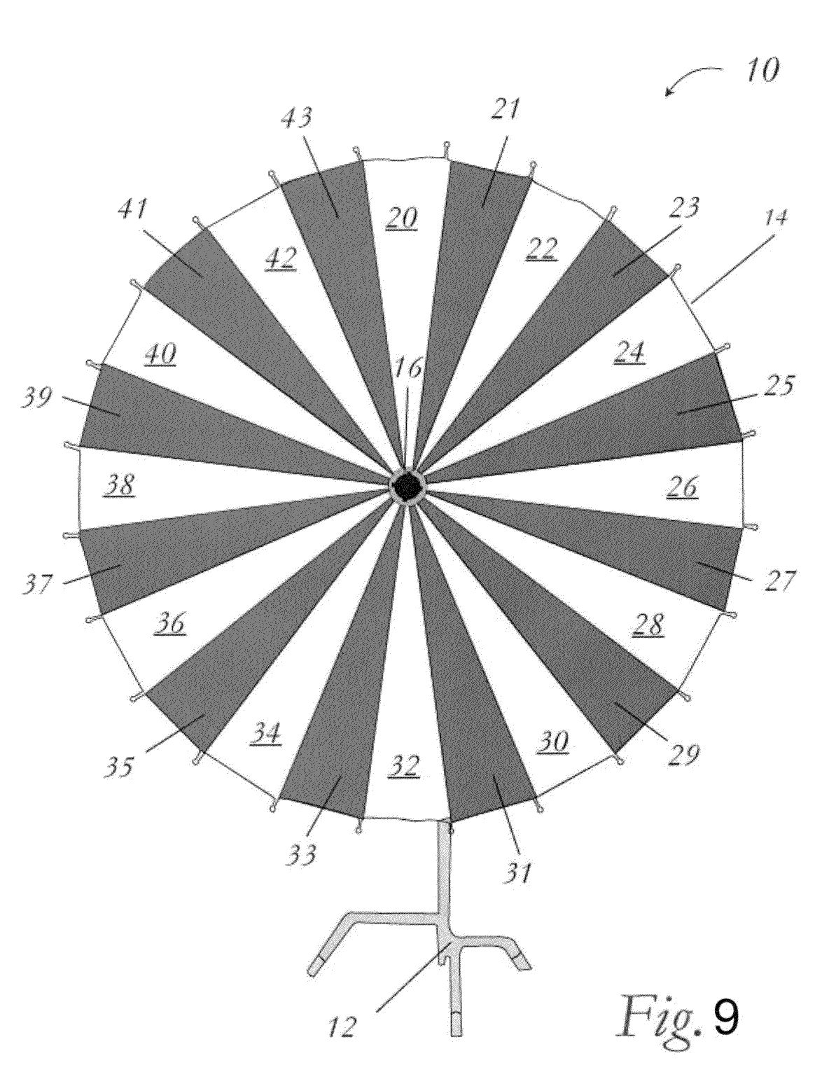

In the embodiment shown in FIG. 5, the second reflector 10 includes one or more LED lights including a strip of LED lights 430 arranged on the second reflector 10. The invention includes LED lights of different colors known to skilled persons and includes LED lights in red, blue and green colors arranged in a RGB color space configuration. In further embodiments, the second reflector 10 includes an arrangement of LED lights 432 as shown in FIG. 6 on a portion of the second reflector 10 including LED lights 432 of variable colors including red, green and blue. Alternative arrangements of individual LED lights 432 on a portion of the light reflecting surface 14 of the second reflector 10 in further embodiments are illustrated in FIG. 7 and in FIG. 8. The strip of LED lights 430 and LED lights 432 can be mounted to the second reflector 10 by being glued on, snapped in, sewn in, laminated in, taped in, riveted in or screwed onto the second reflector 10 or by methods and connectors well known to skilled persons.

The strip of LED lights 430 or LED lights 432 can be used as a modeling light to add subtle or dramatic changes to color temperature when used with flash or constant light sources. The strip of LED lights 430 and LED lights 432 can be used for these purposes with a single reflector or with a multiple reflector arrangement including the first reflector 400 and second reflector 10 apparatus shown and described herein.

In the embodiments shown in FIG. 9, the light reflecting surface 14 is arranged in a series of panels in stripes of alternating colors. The panels 20, 22, 24, 26, 28, 30, 32, 34, 36, 38, 40 and 42 are of one color and the odd numbered panels 21, 23, 25, 27, 29, 31, 33, 35, 37, 39, 41 and 43 are of a color different than the color of the even numbered panels. The even numbered panels are a white color and the odd numbered panels are a different color, including a black color, a champagne color or a silver color. In further embodiments, the even numbered panels are silver in color and the odd numbered panels are a black color or a champagne color. In additional embodiments, the even numbered panels are a champagne color and the odd numbered panels are black in color.

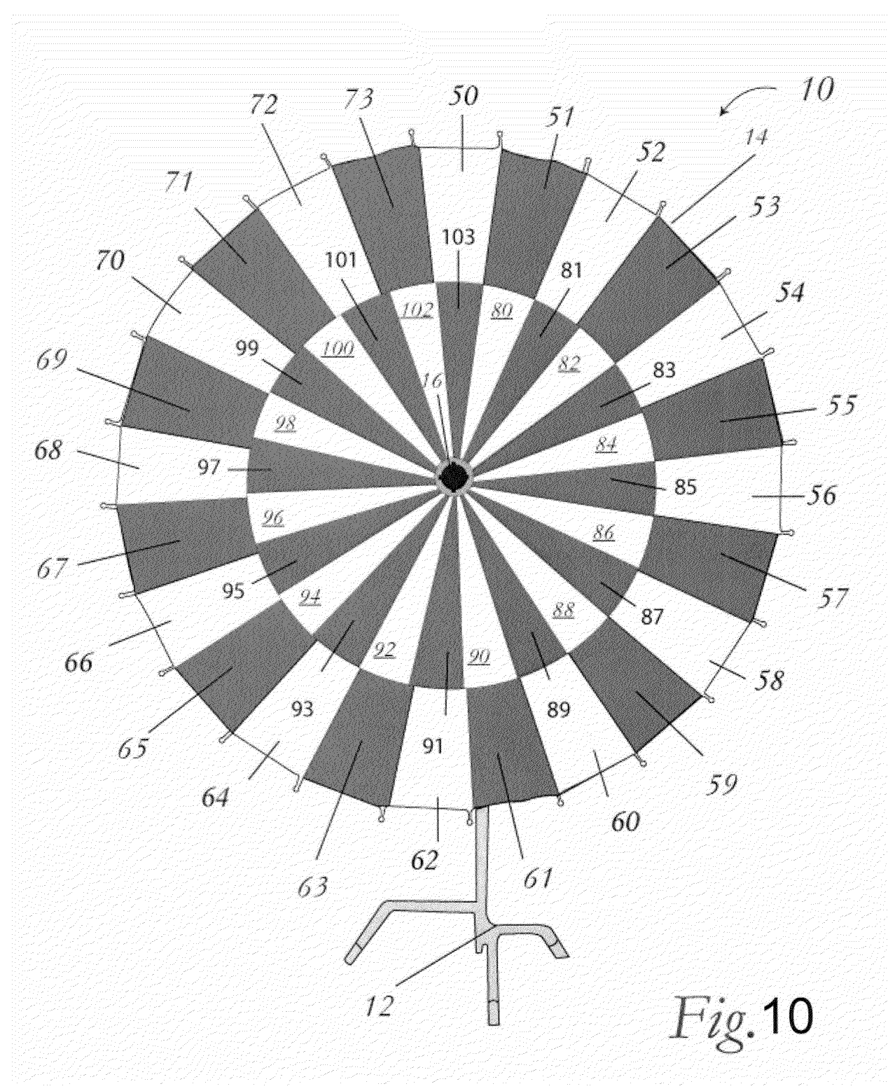

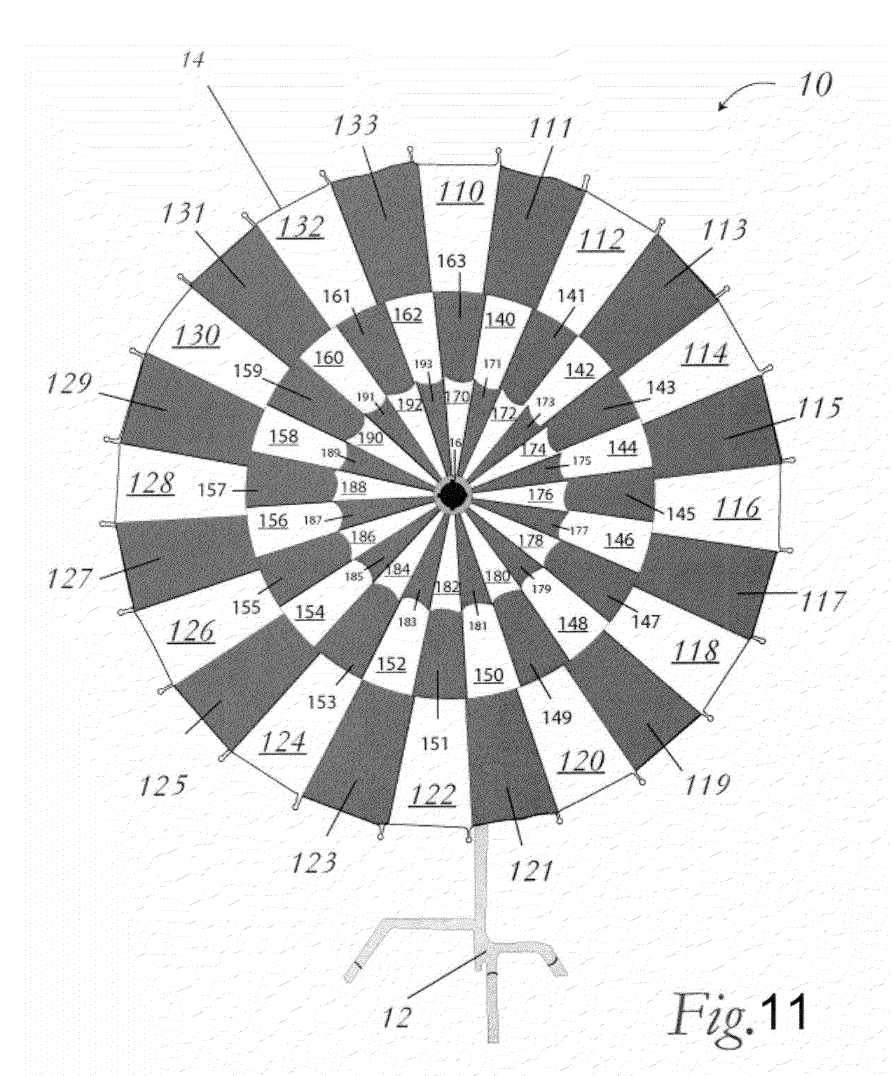

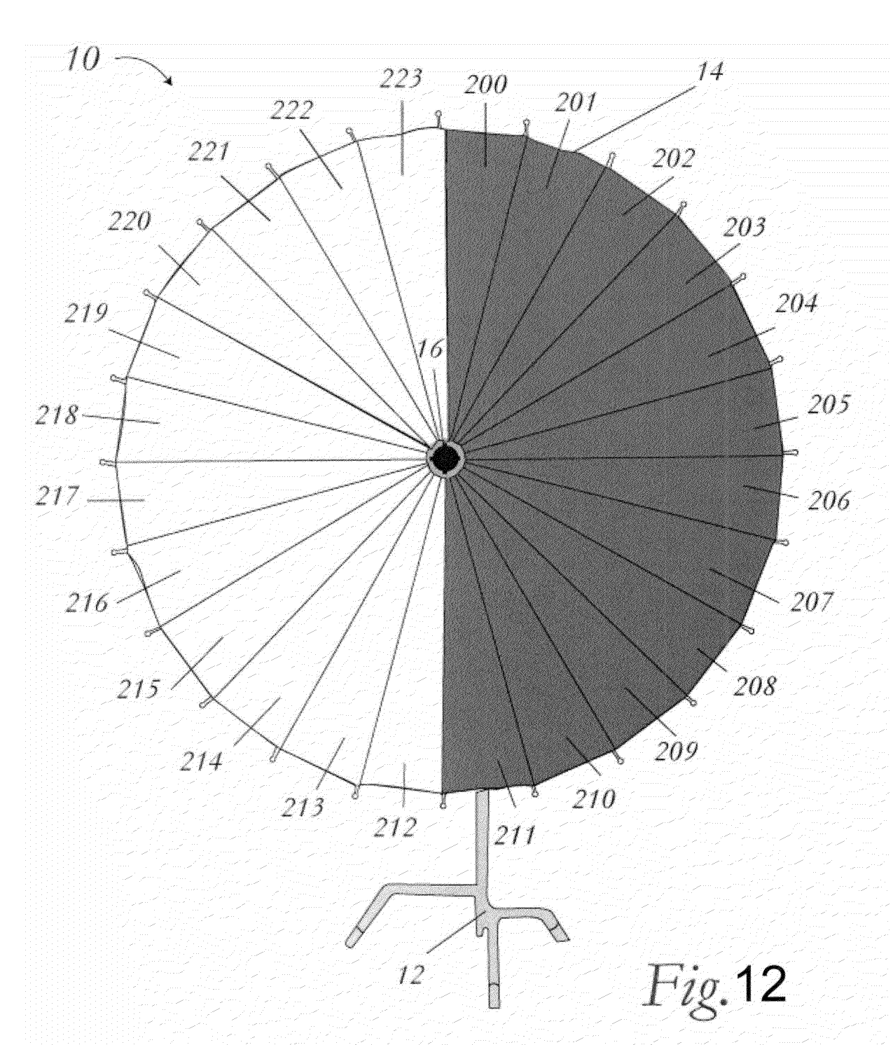

In FIG. 10, the light reflecting surface 14 with a center aperture 16 is shown in a shill or shifted configuration from the configuration shown in FIG. 9. Panels numbered 50-73 are arranged on the skin 14 as shown in FIG. 10 with the even numbered panels being of one color and the odd numbered panels a different color. The color combinations for the panels, include, but are not limited to, black and white, gold and white, silver and white and champagne and white. The panels numbered 80-103 are arranged on the light reflecting surface 14 as shown in FIG. 10 with the even numbered panels being of one color and the odd numbered panels a different color. The same color combinations are available as for panels 50-73. In embodiments of the invention, a panel that is diagonally adjoining a panel in a different ring of panels may be of the same or different color as the adjoining ring and all such color combinations are within the scope of the invention.

In embodiments illustrated in FIG. 11, the light reflecting surface 14 is arranged with panels numbered 110-133 with the even numbered panels being of one color and the odd numbered panels a different color. The color combinations for the panels, include, but are not limited to, black and white, gold and white, silver and white and champagne and white. The light reflecting surface 14 is configured as shown in FIG. 11 in panels numbered 140-163 with the even numbered panels being of one color and the odd numbered panels a different color. The same color combinations are available as for panels 110-133.

The light reflecting surface 14 is configured with panels 170-193 with the even numbered panels being of one color and the odd numbered panels a different color. The same color combinations are available as for panels 110-133 and as for panels 140-163. In embodiments of the invention, a panel that is diagonally adjoining a panel in a different ring, of panels may be of the same or different color as the adjoining ring and all such color combinations are within the scope of the invention.

In FIG. 12, the panels 200-211 of the light reflecting surface 14 are of one color and the panels 212-223 are of one color that is different from the color of panels 200-211. The color combinations for the different colored panels include, but are not limited to, black and white, gold and white, silver and white and champagne and white. For example, panels 200-211 are a black color and panels 212-223 are a white color in one embodiment.

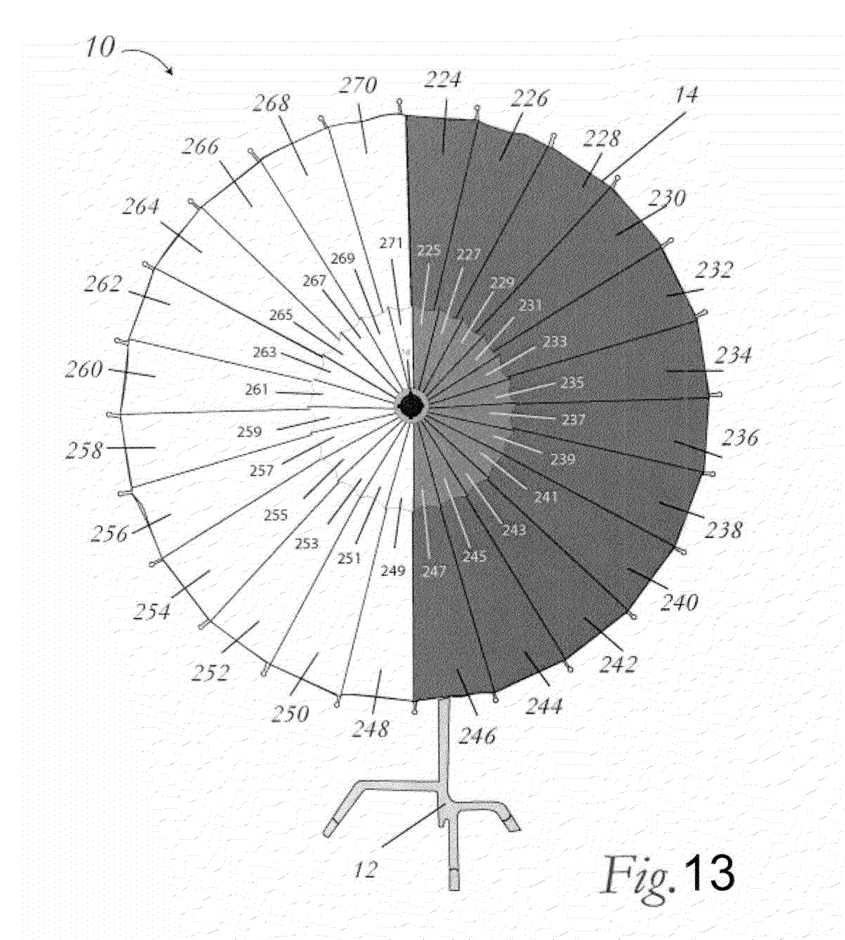

In embodiments illustrated in FIG. 13, the panels 224-246 of the light reflecting surface 14 are of one color and the panels 248-270 are of a different color. The color combinations for the different colored panels include, but are not limited to, black and white, gold and white, silver and white and champagne and white. Also as shown in FIG. 13, these embodiments include panels 225-247 which are of one color and panels 249-271 that are of a different color. The color combinations for the different colored panels include, but are not limited to, black and white, gold and white, silver and white and champagne and white.

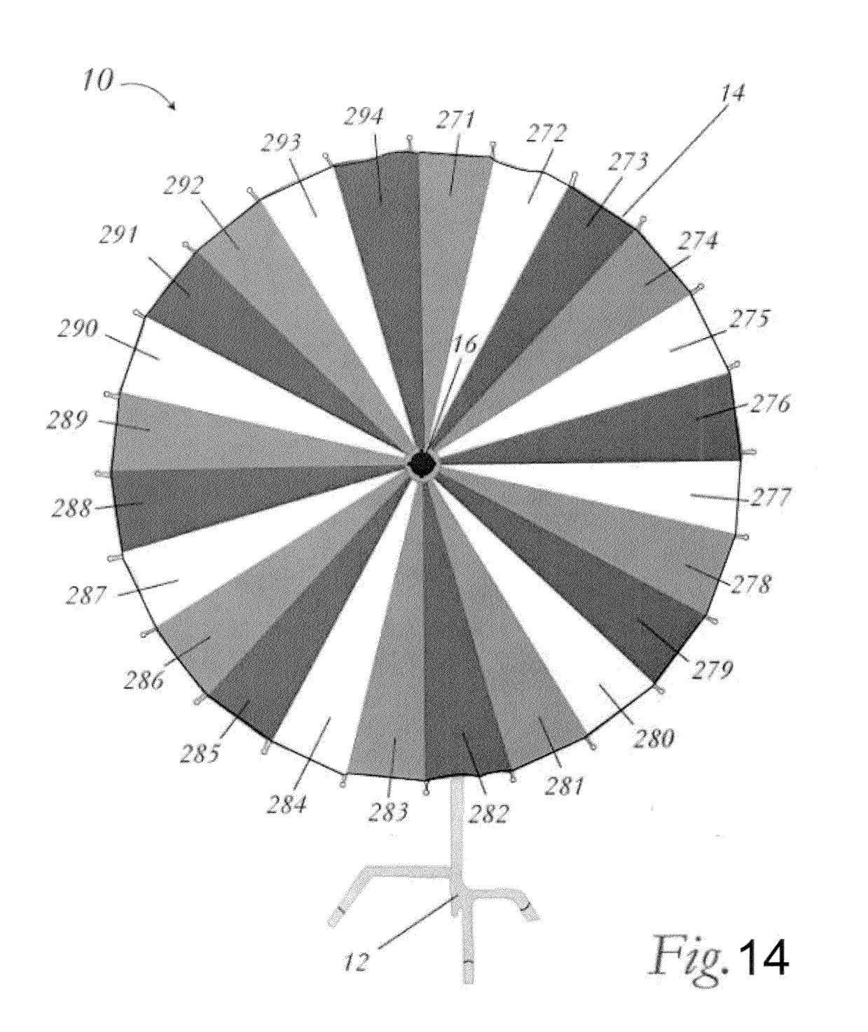

In FIG. 14, the light reflecting surface 14 is shown in a tricolor configuration. In these embodiments, panels 271-294 are arranged in a striped configuration in three alternating colors. In one or more embodiments, the panel colors alternate from black, to silver and to white and in other embodiments, the panel colors alternate among hard silver, soft silver and white. However, the invention includes any combination of alternating colors.

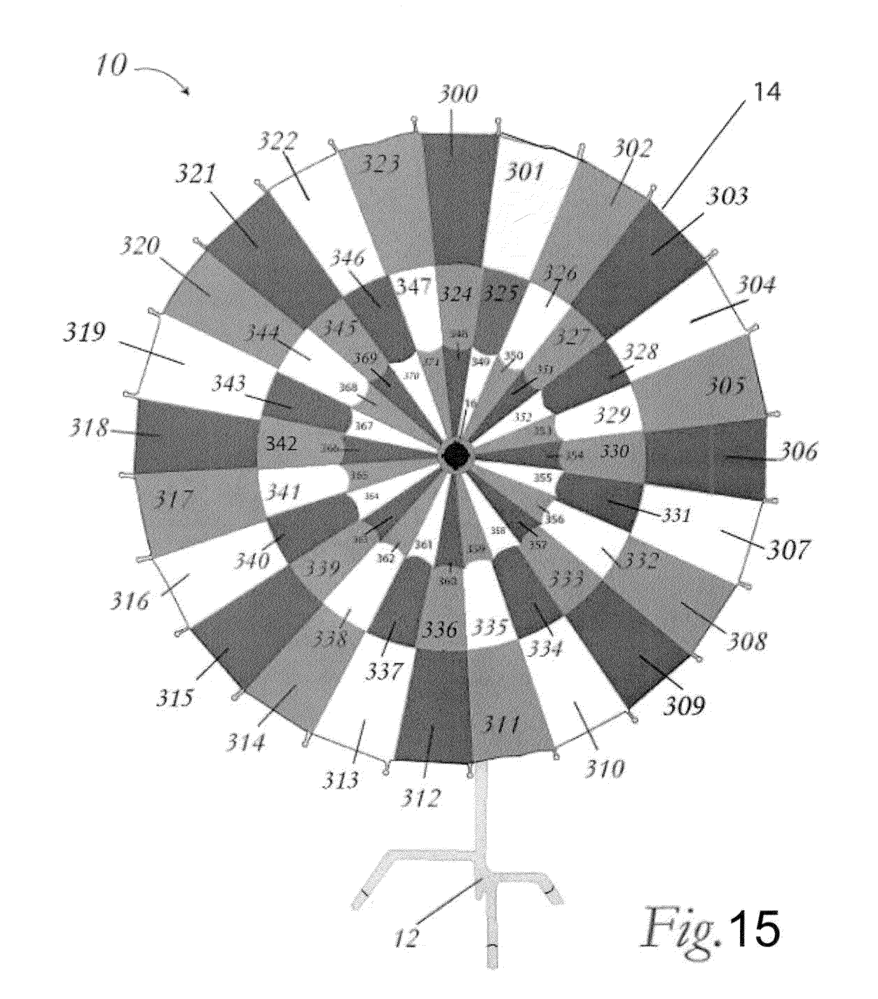

In FIG. 15, the light reflecting surface 14 is shown in a tricolor shift configuration. In these embodiments, the panels numbered 300-322 are arranged on the light reflecting surface 14 with these panels alternating among three colors. The color combinations for the panels, include, but are not limited to; black, white, gold, silver and champagne. The panels numbered 323-346 are arranged on the skin 14 as shown in FIG. 7 with these panels alternating among three colors. The same color combinations are available as for panels 300-322.

The panels 350-373 are arranged on the light reflecting surface 14 with these panels alternating among three colors. The same color combinations are available as for panels 300-322 and as for panels 323-346. In embodiments of the invention, a panel that is diagonally adjoining a panel in a different ring of panels may be of the same or different color as the adjoining ring and all such color combinations are within the scope of the invention.

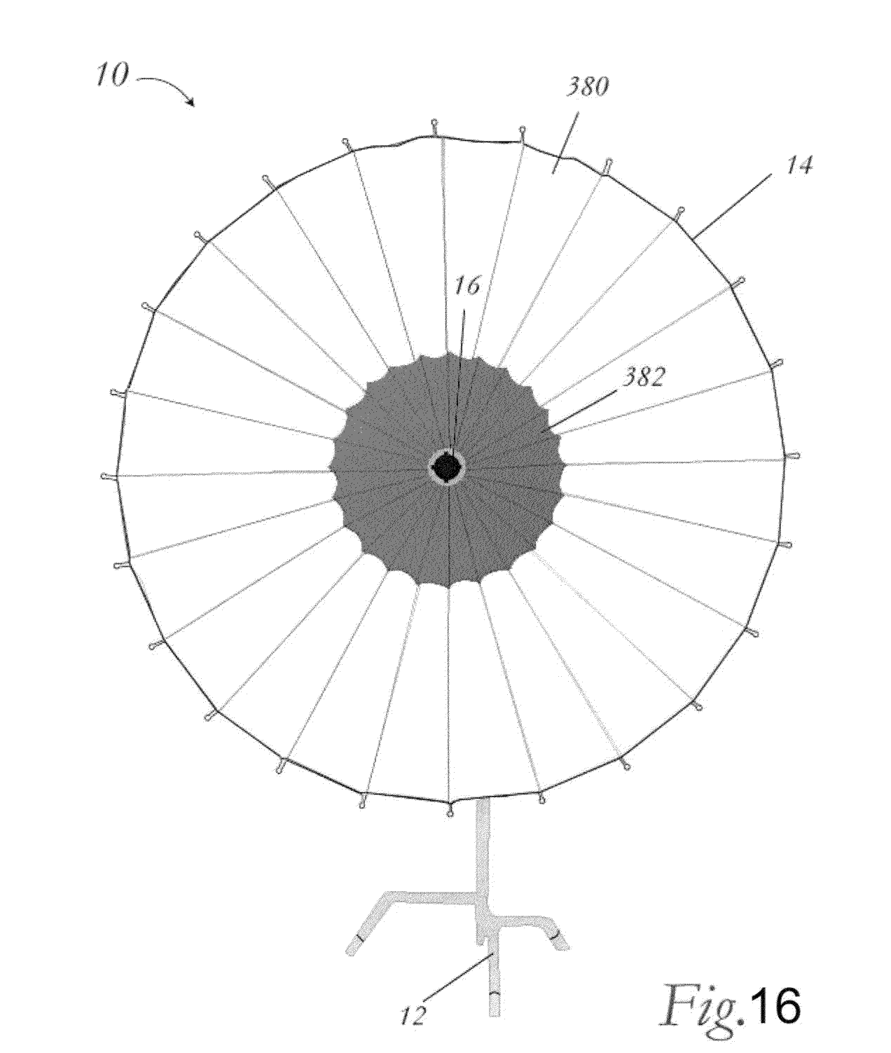

In FIG. 16, the light reflecting surface 14 is shown in an embodiment with the center portion 382 having a different color than the outer portion 380 of the panels. The colors for the center portion 382, include, but are not limited to, black, gold, silver and champagne. The colors for the outer portion 380 include, but are not limited to, white, silver, gold and champagne.

While the present invention has been described with regards to particular embodiments, it is recognized that additional variations of the present invention may be devised by persons skilled in the art without departing from the inventive concepts disclosed herein and the invention is entitled to the full breadth and scope of the claims.

What is claimed is:

1. A light reflecting apparatus with a dual reflector configuration comprising:
a first reflector adapted to be positioned axially adjacent to a lamp, the first reflector having an inner light reflecting surface directed at the lamp and having an exterior light reflecting surface,
the first reflector having a plurality of apertures extending from the inner light reflecting surface to the exterior light reflecting surface; and
a second reflector positioned axially adjacent to the first reflector, the second reflector having a light reflecting surface adjacent to the exterior light reflecting surface of the first reflector.

2. The apparatus of claim 1 wherein the light reflecting surface of the second reflector comprises light reflecting panels that alternate between a first color and a second color different from the first color.

3. The apparatus of claim 1 wherein the inner light reflecting surface and the exterior light reflecting surface of the first reflector include one or more translucent portions.

4. The apparatus of claim 1 wherein the second reflector is a parabolic reflector.

5. The apparatus of claim 1 further comprising a second lamp positioned between the first reflector and the second reflector.

6. The apparatus of claim 1 wherein the light reflecting surface of the second reflector includes at least one LED light source.

7. The apparatus of claim 1 wherein the light reflecting surface of the second reflector comprises a shift configuration.

8. The apparatus of claim 1 wherein the light reflecting surface of the second reflector comprise a checkered shift configuration.

9. The apparatus of claim 1 wherein the light reflecting surface of the second reflector comprises a half and half configuration.

10. The apparatus of claim 1 wherein the light reflecting surface of the second reflector comprises a center portion of one color and an outer portion of a different color.

11. The apparatus of claim 1 wherein the light reflecting surface of the second reflector comprises a tricolor configuration or a tricolor shift configuration.

12. A light reflecting apparatus comprising:
a first reflector adapted to be positioned adjacent to a light source, the first reflector having an inner light reflecting surface and an exterior light reflecting surface, the inner light reflecting surface including an inner translucent panel and the exterior lighting surface including an exterior translucent panel; and
a second reflector configured axially adjacent to the first reflector, the second reflector having a light reflecting surface adjacent to the exterior surface of the first reflector.

13. The apparatus of claim 12 further comprising the light reflecting surface of the second reflector includes light reflecting panels that alternate between a first color and a second color different from the first color.

14. The apparatus of claim 12 further comprising at least one aperture extending from the inner surface to the exterior surface of the first reflector.

15. The apparatus of claim 12 wherein the light reflecting surface of the second reflector includes at least one LED light source.

16. A light reflecting apparatus comprising:
a first reflector adapted to be positioned adjacent to a light source, the first reflector having an inner surface comprising a plurality of inner panels and having an exterior surface comprising a plurality of exterior panels,
the first reflector having at least one aperture extending between one of the inner panels and one of the exterior panels, at least one inner panel comprising a light reflecting surface and at least one exterior panel comprising a light reflecting surface; and
a second reflector positioned axially adjacent to the first reflector, the second reflector having a light reflecting surface adjacent to the exterior surface of the first reflector, the light reflecting surface of the second reflector having a plurality of light reflecting panels that alternate between a first color and a second color different from the first color.

17. The light reflecting apparatus of claim 16 wherein the light reflecting surface of the second reflector comprises light reflecting panels that alternate between a first color and a second color different from the first color.

18. The light reflecting apparatus of claim 16 wherein the inner light reflecting surface and the exterior light reflecting surface of the first reflector include one or more translucent portions.

19. The light reflecting apparatus of claim 16 further comprising a second light source positioned between the first reflector and the second reflector.

20. The light reflecting apparatus of claim 16 further comprising at least one LED light source secured to the light reflecting surface of the second reflector.
